(19) United States
(12) Patent Application Publication
(10) Pub. No.: US 2016/0035186 A1
(43) Pub. Date: Feb. 4, 2016

(54) Total Baccarat Improvements

(71) Applicant: Han Suk Oh, Catonsville, MD (US)

(72) Inventor: Han Suk Oh, Catonsville, MD (US)

(21) Appl. No.: 14/447,158

(22) Filed: Jul. 30, 2014

(51) Int. Cl. G07F 17/32; A63F 1/06

(52) U.S. Cl. CPC G07F 17/3244; A63F 1/065; A63F 2001/001

(57) ABSTRACT

A method of playing Baccarat and Baccarat derivative games such as mini-Baccarat and midi-Baccarat which incorporates optional new bets without affecting the normal play. The bettors may wager on these bets based on the sum point total of both the Player and the Banker hands. The bettors may chose Low (0-2), Middle (3-10), or High point total (11-18). [[In an another embodiment, the bettors are afforded the choices of Even, Odd or any combinations based on point total of both the Player and Banker hands.]] Different payouts may be set by the established to give the house the edge. In preferred embodiments, these bets are made electronically via touch screens, and the cards are scanned electronically in a manually dealt shoe or with an electronic shoe simulating physical cards using a computer.

### BACKGROUND OF THE INVENTION

1. Field of the Invention

This invention relates to the field of casino gambling, specifically to improvements in Baccarat wagering. These embodiments may be applied to any Baccarat and Baccarat derivative games such as Mini-Baccarat, and Midi-Baccarat. This can be played in a live casino setting and also in an electronic setting via internet and via computer interface with appropriate software and algorithms.

2. Background of the Art

The most popular form of Baccarat is punto banco Baccarat hereafter to be referred as Baccarat. The standard rules of Baccarat are known, so there is no need to inform those having ordinary skill in the art on how Baccarat is played. Baccarat is a well established casino game where using established rules, bets are placed where the object is for the bettor to choose the side with the closest point total of 9. Cards are given point values. Ace, have a point value of one, and all numeric cards have value equal to the value of the number on the card, and the value of jacks, queens, and kings are zero. For example, two card being dealt to the Player side which are 7 of clubs and 5 of hearts will have a point value in baccarat of two because all value in the tens places are ignored and only the values in the ones are counted. Cards are dealt first to the Player, then to the Banker, then to the Player and then to the Banker. There may be slight variation of rules, in various casinos but the following rules are standard in Baccarat. When the Player's first two cards total 0-5, the Player draws another card. If the Player's two card total total 6-7, the Player stands pat and does not draw a card. When the Player's first two card total 8-9, the Player stands pat and the Banker stands pat. If the Banker's first two cards total 3, the Banker draws another card if the third card drawn by the Player has any of these values, (1,2,3,4,5,6,7,9,0) and does not draw if the Player's third card is an 8. If the Banker's first two cards total 4, the Banker draws another card if the third card drawn by the Player has any of these values, (2,3,4,5,6,7) and does not draw if the Player's third card has any of these values (1,8,9,0). If the Banker's first two cards total 5, the Banker draws another card if the third card drawn by the Player has any of these values, (4,5,6,7) and does not draw if the Player's third card has any of these values (1,2,3,8,9,0). If the Banker's first two cards total 6, the Banker draws another card if the third card drawn by the Player side has any of these values, (6,7) and does not draw if the Player's third card has any of these values (1,2,3,4,5,8,9,0). Should the Banker have a two card point total of 7, the banker does not draw another card. Should the Banker have a two card point total of either 8 or a 9, neither hands draw another card. The possible outcomes in a hand of Baccarat are “Player” side win, “Banker” side win, or a “Tie.” The “Player” does not refer to the betting player, nor does the “Banker” refer to the house, but rather they are just betting choice afforded the bettor.

Prior art Baccarat suffers from certain limitations, where most commonly, there are no other betting options than betting on the “Player”, “Banker”, or the “Tie” bet. While Baccarat is exciting and enjoyable to play, there lacks options, and a bet with higher payout than what is currently offered. Baccarat lacks a bet that bettors can play alongside with the main bet and is an alternative to the main bet. Additionally, a side bet does not exist in the conventional Baccarat with a higher payout than the “Tie” bet . A need exist for improvements to allow conventional Baccarat game more variations of play, to keep player's interest from waning and keep this game profitable for casinos.

This invention benefits the casino with positive expectation and benefits bettors with exciting betting option with larger payout than the main bets, and an alternative main bet based on the point total of the “Player” and “Banker”.

### SUMMARY OF THE INVENTION

In accordance with the present invention, new bets thereto referred to herein as “Low”, “Middle”, and “High” bets, allows for increase excitement for players by allowing for different betting options and a bet with a higher payout than what is currently offered on conventional Baccarat. The Low, Middle, and High bets collectively is named “Total” bets. Wagers are accepted on the main bets of Player, Banker or Tie. The Total bets may be wagered independent of the current Baccarat bets, and does not affect the play of the game of Baccarat. The sum total of the Player's hand and Banker's hand will be used in determining winner of the Low, Middle, and High bets. The Low bet wins if the sum of the Player's and Banker's hand are (0,1,2) and is paid 30:1 and loses on any other point total of the Player's and Banker's hand. The Middle bet wins if the sum of the Player's and Banker's hand are (3,4,5,6,7,8,9,10) and is paid 0.95:1. The High bet wins if the sum of the Player's and Banker's hand are (11,12,13,14,15,16,17,18) and is paid 1:1 If a bettor wages on the Middle bet and the outcome is a point value 11 or greater, the bettor loses the Middle bet, however if the point value is 2 or less, the Middle bet is a push, neither a win or a loss. If a bettor wages on the High bet and the outcome is any of these point value (3,4,5,6,7,8,9,10), the bettor loses the High bet, however if the point value is 2 or less, the High bet is a push, neither a win or a loss.

The chance of a Low bet occurring is much lower that the other two bets, hence the greater payout of 30:1. The Middle bet is paid even money minus a five percent commission. The High bet is paid even money. These payouts are made to give the house an edge. Although these are the recommended payouts, the casino may change the payouts to fit their needs.

The Low, Middle and High bet indices will be on typical Baccarat layouts with betting spots for these specific bets. The Low bet will be next to the Tie bet, the Middle bet will be next to the Banker bet, and the High bet will be next to the Player bet.

[[In an another embodiment, bettors are afforded a different betting options based on point total of the Player hand and the Banker hand being even, odd, or low. The Even bet wins if the final point total of the Player and Banker hands are any of the following values (1,3,5,7,9,11,13,15,17) and loses on all other point total. The Odd bet wins if the final point total of the Player and Banker hands are any of the following values (2,4,6,8,10,12,14,16,18) and loses on all other point total. The Low bet wins on a point total of (0,1,2) abd loses on all other point total.

Winning Odd bets are paid 0.95 to 1. Winning Even bets are paid 1 to 1. Winning Low bets are paid 28 to 1. The Even, Odd and Low bet indices will be on typical Baccarat layouts with betting spots for these specific bets. The Low bet will be next to the Tie bet, the Odd bet will be next to the Banker bet, and the Even bet will be next to the Player bet.]]

### BREIF DESCRIPTION OF THE DRAWINGS

The accompanying flowchart sheds light on the embodiments of the present invention, as well as its features, advantages, structure and operation.

FIG. 1 is a flowchart elucidating the current method of the present invention; illustrating the Low, Middle, and High bet, according to an embodiment, which is to be performed on an electronic processor.

[[FIG. 2 is a flowchart elucidating the current method of the present invention; illustrating the Even, Odd, and Low bet, according to an embodiment, which is to be performed on an electronic processor.]]

### DETAILED DESCRIPTION OF THE INVENTION

Although this invention is described with one or more preferred embodiments, the invention is not limited by the embodiments. Modifications and variations which fall within the spirit and scope of this invention are complexo. A description of the preferred embodiment is provided herein and should not be limited to the examples provided. A person having ordinary skill in the art may modify the layout, artwork, pay table, specific part shape and details. The examples provided should be construed for better understanding of the invention and functionality, rather than limiting its scope. These include playing Baccarat electronically, with bingo balls, with varying number of deck of cards, different layouts, and any other methods by those with ordinary skills may use to play Baccarat and use this invention. This invention is to encompass all variations of Baccarat. Baccarat played on varying size tables are to be included, including Mini-Baccarat and Midi-Baccarat. Version of Baccarat including but not limited to Punto banco Baccarat, Chemin de Fer, and Baccarat Banque allow for these bets.

An electronic size Midi-Baccarat table layout modified to allow plurality of players to make wager on these bets. Each bettor has their own High, Middle, Low bet indicia where they may wager on these bets. In addition to the standard betting spots of Banker, Player, Tie, each bettor will also have these High, Middle, Low betting spots. All bets must be booked before any cards are removed from the shoe.

In an another embodiment, an electronic size Midi-Baccarat table layout modified to allow plurality of players to make wager on the Even, Odd, or Low bets. Each bettor has their own indices where they may wager on these bets.

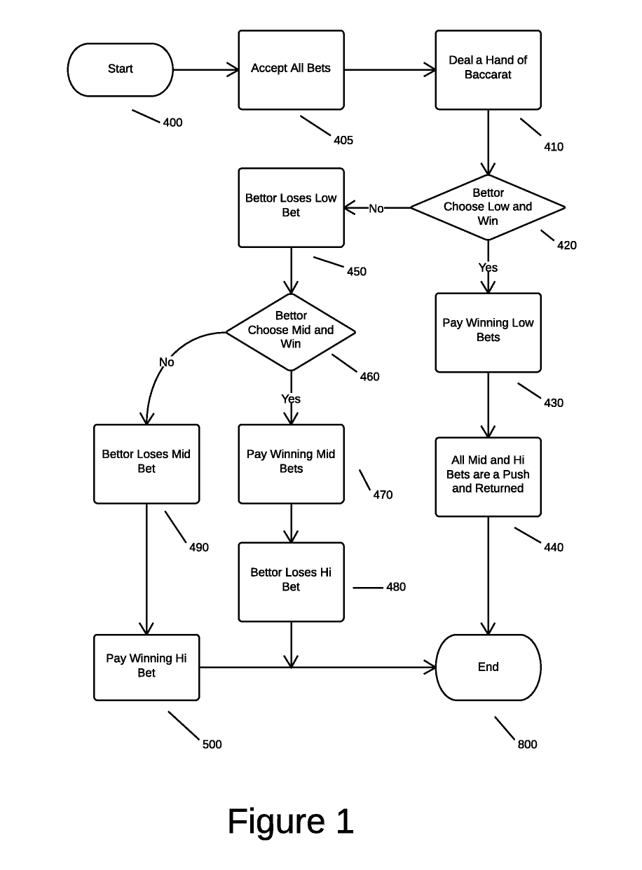

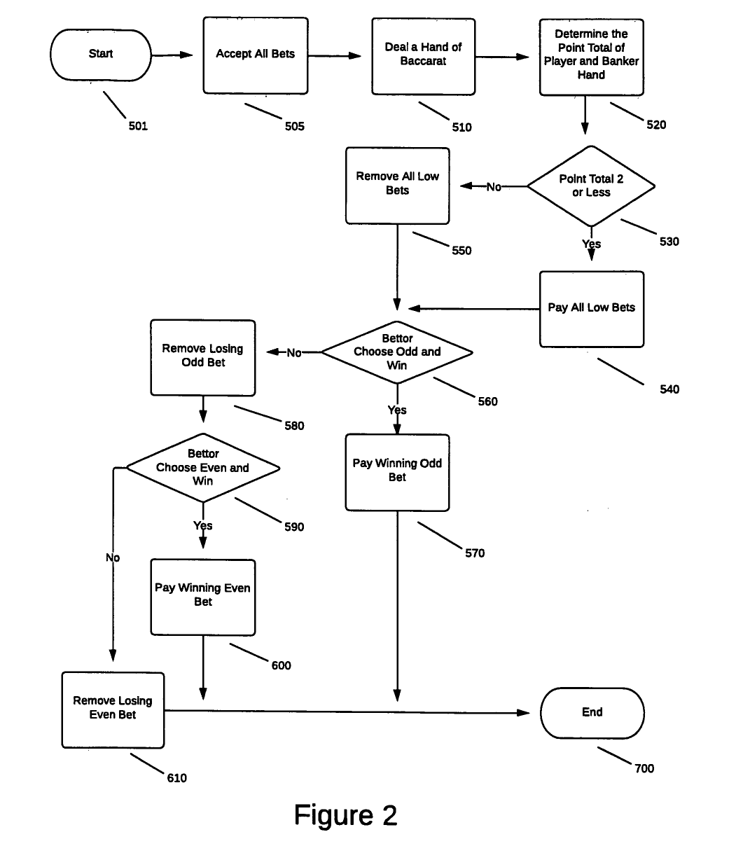

FIG. 1 shows a flowchart showing the detailed exemplary method of implementing Total bets. We start the operation from method 400, the start of this process. At method 405, all bets are accepted including the High, Middle, and Low bets. Method 410, the croupier deals a hand of Baccarat. Method 420, croupier determines whether sum of the Player and Banker hand is 2 or less. If this occurred the operation moves to method 430, where the Low bet is paid. All wagers on Middle and High bets are returned to the bettors as to method 440 and concludes with method 800 and ends. If the bettor choses Low and the point total is 3 or greater, we move to method 450 where the bettor loses the Low bet. Next at method 460, we check to see if the Bettor chose the middle bet. If the sum of the Player and Banker hand is from 3 to 10, inclusive, we move to method 470 and pay the middle bet followed by method 480 and take all bets placed on High bet and conclude at method 800 and end. If at method 460, that the sum of the Player and Banker hand is 11 or greater, we move to method 490 and take the Middle bet and proceed to method 500 and pay the High bet and conclude with method 800 and end.

The outcome of the High, Middle, and Low bets will be paid as follows: High bet are paid 1:1, Middle bets are paid 0.95:1, and Low bets are paid 30:1. If the outcomes is Low any wagers on High and Middle bets are returned to the bettors. This payout will be clearly know to all bettors either by being printed on the felt, printed on a rack card, displayed on a screen, or conveyed by any other methods such that the bettors know the payout for these bets. This pay table is set as a guide and should not be considered limiting in scope. Pay table may be adjusted in payout value but never set to give the house an edge greater than what is set by the jurisdictions allowing this bet.

[[FIG. 2 shows a flowchart showing the detailed exemplary method of implementing Even, Odd, and Low bets. We start the operation from method 501, the start of this process. At method 505, all bets are accepted including the Even, Odd, and Low bets. Method 510, the croupier deals a hand of Baccarat. Method 520, croupier determines the total sum of the final Player and Banker hand. Method 530, croupier checks to see if the point total is two or less. Method 540 pays all Low bets if the point total is two or less. If not, at method 550, all Low bets are removed. Method 560 checks to determine if the point total is an odd value. Method 570 pays out any winning Odd bets. If the point total is not odd, we move to method 580 and remove all losing odd wagers. Method 590 checks for any Even wagers made by the bettors. Method 600 pays all winning Even wagers and method 610 removes all losing Even bets. Method 700, everything concludes and ends.]]

The details and specifications in the claims are meant to elucidate the advantages of the invention, not meant to be limiting the scope of the invention. Suitable modifications, design of the layout, varying pay tables, and equivalents which fall within the spirit and scope of this invention may be deemed covered by the following claims.

1. A method of playing new bets for Baccarat game, including such variations as punto banco Baccarat, Chemin de Fer, Baccarat Banque, Midi-Baccarat, Mini-Baccarat, Neveda-style Baccarat, Scarney Baccarat and any other variations of Baccarat where the sum total of, both the final Player's hand and final Banker's hand, is used to create new betting opportunities, said method comprising the steps of:
a) performing, on an electronic processor, the operation of: allowing at least one bettor to wager on either the main bet of Player, or Banker, or Tie;
b) performing, on an electronic processor, the operation of: allowing at least one bettor to wager on Total Baccarat bets of High, Middle, Low bets;
c) performing, on an electronic processor, the operation of: the computer dealing at least one Player's hand and a Banker's hand in a manner consistent with the rules of Baccarat;
d) performing, on an electronic processor, the operation of: resolving the main bet with the rules of Baccarat;
e) performing, on an electronic processor, the operation of: resolving the Total Baccarat bets;
f) performing, on an electronic processor, the operation of: resolving other bets based on the sum total of of the final Player's hand and final Banker's hand differing from the Total Baccarat bets.

2. The method of claim 1 wherein the outcome of the Total Baccarat bets are: performed on an electronic processor, the operation of:
a) Low, the point total of the final Player and final Banker hands are (0,1,2), between 0 to 2 inclusive, which results in the Low bet being paid 30:1, the Middle and High bets are returned to the bettors.
b) Middle, the point total of the final Player and Banker hands are (3,4,5,6,7,8,9,10), between 3 to 10 inclusive, the bettor is paid 0.95:1, the Low, and High bets losing;
c) High, the point total of the final Player and final Banker hands are (11,12,13,14,15,16,17,18), between 11 to 18 inclusive, the bettor is paid 1:1, the Low, and Middle bets losing;
d) where the Total Baccarat bets are awarded on a different pay tables to suit the needs of the establishment offering these bets;
e) where, the grouping may be set as high(11-18) and low(0-10), or any grouping which requires using the sum total of the final Player and Banker hands.

3. The method of claim 1 wherein the outcome of the Total Baccarat bets are:
performed on an electronic processor, the operation of:
a) Low, the point total of the final Player and final Banker hands are (0,1,2), between 0 to 2 inclusive, which results in the Low bet being paid 30:1. Odd bet losing unless the point total is 1 and the Even bet losing unless the point total is 2.
b) Odd, the point total of the final Player and Banker hands are (1,3,5,7,9,11,13,15,17), the bettor is paid 0.95:1, the Low bet losing unless the point total is (1), and Even bets losing;
c) Even, the point total of the final Player and Banker hands are (2,4,6,8,10,12,14,16,18), the bettor is paid 1:1, the Low bet losing unless the point total is (2), and Odd bets losing;
d) different pay tables may be used to suit the needs of the establishment offering these bets;
e) where, any other grouping may be used which requires the sum total of the final Player and Banker hands such as even/odd, high/low, over/under, group falling within a range of the point total, or any other grouping which falls within the spirit or scope of this invention.
